(19) United States
(12) Patent Application Publication
(10) Pub. No.: US 2021/0022378 A1
(43) Pub. Date: Jan. 28, 2021

(54) METHOD OF MANUFACTURING SHEET KIMCHI HAVING SPICY TASTE

(71) Applicant: Jung Min KIM, Daejeon (KR)

(72) Inventors: Jung Min KIM, Daejeon (KR); Duck Kyu PARK, Daejeon (KR)

(73) Assignee: Jung Min KIM, Daejeon (KR)

(21) Appl. No.: 16/845,932

(22) Filed: Apr. 10, 2020

(30) Foreign Application Priority Data
Jul. 22, 2019 (KR) 2019-0088329

(51) Int. Cl. A23L 19/20; A23L 19/00

(52) U.S. Cl. CPC A23L 19/20; A23V 2002/00; A23L 19/03

(57) ABSTRACT

The present invention relates to a method of manufacturing a sheet kimchi having a spicy taste, the method including separating chinese cabbage into sheets to prepare sheets of chinese cabbage leaves, pickling the sheets of the chinese cabbage leaves with a brine pickling solution, applying a kimchi seasoning, which includes a red pepper powder, an anchovy sauce, a sauced shrimp, minced garlic, ginger, starch syrup, L-monosodium glutamate, a roasted coffee bean powder, and a fruit extract of pepper, on the sheets of the chinese cabbage leaves and sequentially stacking and packing the sheets of the chinese cabbage leaves. According to the present invention, since the roasted coffee bean powder and the fruit extract of the pepper are included in the kimchi seasoning, a spicy taste of the kimchi is increased, and a decrease in spicy taste is suppressed even when the kimchi is stored for a long time.

### CROSS-REFERENCE TO RELATED APPLICATION

The present invention claims priority under 35 U.S.C. §119 to Korean Application No. 2019-0088329 filed on Jul. 22, 2019, the entire content of which is incorporated herein by reference.

### BACKGROUND

### 1. Field of the Invention

The present invention relates to a method of manufacturing a sheet kimchi having a spicy taste, in which a kimchi seasoning is applied on chinese cabbage leaves separated into sheets, thereby expressing a spicy taste.

### 2. Discussion of Related Art

Kimchis are Korea's representative traditional fermented food with a very unique taste and flavor.

In general, the kimchi is made by mixing main raw materials such as chinese cabbage and daikon, subsidiary raw materials such as green onion, garlic, ginger, and water parsley, and seasonings such as a red pepper powder and a condiment, adjusting a saline concentration, adding salted fish, and fermenting the resultant mixture through ripening.

In a process of fermenting the kimchi, pathogenic microorganisms are disinfected by lactic acid bacteria increased, and sugar in vegetables is converted into a lactic acid so that the kimchi has a clean taste.

A bacterium called leuconostoc mesenteroides acts on the fermentation of the kimchi at an early stage to ripen the kimchi to a proper degree. Thereafter, a bacterium called lactobacillus plantarum acts on the fermentation of the kimchi at middle and late stages to kill harmful bacteria, but to make an excessively large quantity of acid, thereby causing the kimchi to be soured.

The kimchi is fermented by adding various kinds of salted fish according to regions. Thus, there are kimchis having various flavors and types according to regions, and the kimchi contains nutrients essential to the human body.

Conventionally, a kimchi is made by preparing a kimchi raw material, preparing a seasoning to be added to the raw material, adding the seasoning to the kimchi raw material, and fermenting the kimchi raw material in a sealed container.

When the preparing of the kimchi raw material is described as an example, the kimchi raw material is chinese cabbage, the chinese cabbage is washed clean and is dipped into brine for 10 hours to 15 hours so that the brine permeates into the chinese cabbage to reduce crispness of the chinese cabbage. After that, the chinese cabbage is taken out of the brine and is naturally dehydrated.

When the preparing of the seasoning is described, radish is cut into thin strips, salt is sprinkled onto the radish strips, and a dried red pepper powder and crushed garlic and ginger are mixed together with the radish strips. In this case, various kinds of salted fish and a condiment are mixed with the radish strips according to preference.

When the adding of the seasoning and the fermenting of the kimchi raw material are described, the seasoning is put into a gap between pickled chinese cabbage leaves, that is, a kimchi raw material, a seasoning liquid from the seasoning is applied on surfaces of the chinese cabbage leaves, a body of the chinese cabbage is wrapped with end portions of the chinese cabbage leaves, and the chinese cabbage is contained in a sealed container. Then, the chinese cabbage in the container is fermented at room temperature for two days to fifteen days according to the season, thereby obtaining a delicious kimchi.

However, when a certain period of time elapses after the kimchi is made as described above, a large amount of kimchi seasoning liquid is generated by water discharged from the chinese cabbage and the seasoning. Accordingly, the chinese cabbage of the kimchi accommodated together in the container absorbs the kimchi seasoning liquid, and thus, the kimchi becomes tender.

As a result, a chewing property of the kimchi is degraded, and a spicy seasoning is neutralized to some extent by water, resulting in a less spicy taste.

### RELATED ART DOCUMENTS

### Patent Documents

Korean Patent Publication No. 2012-0128269 (Title of the Invention: KIMCHI MANUFACTURING METHOD INCLUDING PROCESS OF DRYING KIMCHI MATERIAL).

### SUMMARY OF THE INVENTION

The present invention is directed to improve a manufacturing method in order to maintain a spicy taste and texture right after a kimchi is made even when a certain period of time elapses.

According to an aspect of the present invention, there is provided a method of manufacturing a sheet kimchi having a spicy taste, the method including separating chinese cabbage into sheets to prepare sheets of chinese cabbage leaves, pickling the sheets of the chinese cabbage leaves with a brine pickling solution, preparing a kimchi seasoning by mixing 20 to 30 parts by weight of an anchovy sauce, 20 to 30 parts by weight of a sauced shrimp, 40 to 60 parts by weight of minced garlic, 40 to 60 parts by weight of ginger, 20 to 30 parts by weight of starch syrup, 5 to 10 parts by weight of L-monosodium glutamate, 5 to 10 parts by weight of a roasted coffee bean powder, and 5 to 10 parts by weight of a fruit extract of pepper with respect to 100 parts by weight of a red pepper powder, and applying the kimchi seasoning on the sheets of the chinese cabbage leaves and sequentially stacking and packing the sheets of the chinese cabbage leaves.

### DETAILED DESCRIPTION OF EXEMPLARY EMBODIMENTS

The present invention includes pickling sheets of chinese cabbage leaves with a brine pickling solution, applying a kimchi seasoning including a roasted coffee bean powder and a fruit extract of pepper on the sheets of the chinese cabbage leaves, and sequentially stacking and packaging the sheets of the chinese cabbage leaves.

The sheets of the chinese cabbage leaves are prepared by cutting off a root of chinese cabbage, spreading and separating chinese cabbage leaves into sheets, and washing the chinese cabbage leaves.

Since picking with brine is facilitated due to the sheets of the chinese cabbage leaves, the pickling is uniformly performed, and a pickling time is reduced. In addition, due to use of the sheets of the chinese cabbage leaves, after the pickling, dehydration may be facilitated, a kimchi seasoning may be well absorbed into the sheets of the chinese cabbage leaves due to water being removed by the dehydration, and a spicy taste of the kimchi seasoning may be maintained in the kimchi for a long time.

In addition, since the kimchi is made of the sheets of the chinese cabbage leaves, many different kimchi seasonings may be added to the chinese cabbage leaves, and the adding operation may become easy.

An operation of dipping and picking the sheets of the chinese cabbage leaves with the brine pickling solution for 4 hours to 8 hours is performed.

In this case, generally known typical methods may be used.

The kimchi seasoning may be prepared by mixing 20 to 30 parts by weight of an anchovy sauce, 20 to 30 parts by weight of a sauced shrimp, 40 to 60 parts by weight of minced garlic, 40 to 60 parts by weight of ginger, 20 to 30 parts by weight of starch syrup, 5 to 10 parts by weight of L-monosodium glutamate, 5 to 10 parts by weight of a roasted coffee bean powder, and 5 to 10 parts by weight of a fruit extract of pepper with respect to 100 parts by weight of a red pepper powder.

In order to emphasize a spicy taste, the red pepper powder may be used by pulverizing chungyang pepper, including seeds thereof. The red pepper powder according to the present invention is a red pepper powder which is obtained by pulverizing dried chungyang pepper once instantly when the seasoning is prepared, rather than a red pepper powder which is pulverized multiple times and dried. Thus, the red pepper powder is a red pepper powder of which a particle size is greater than that a general red pepper powder and which is fresh and very spicy.

Capsaicin of red pepper exhibiting a spicy taste has high volatility, is unstable to heat, and is degraded when being stored for a long time. Accordingly, when a kimchi is stored for a long time, a spicy taste of the kimchi is reduced. In order to prevent the reduction in the spicy taste, it is necessary to add a large amount of red pepper powder from the beginning, which is not only economically disadvantageous, but also causes a problem in that an initial spicy taste of the kimchi is too strong and pungent.

In the present invention, since the roasted coffee bean powder is added to the kimchi seasoning, it is possible to further enhance a spicy taste of kimchi without using a large amount of red pepper powder.

Coffee beans include a large amount of bitter chlorogenic acid. When the coffee beans are roasted, the chlorogenic acid is hydrolyzed to generate a quinic acid in which a bitter taste is removed. The quinic acid may enhance a spicy taste.

The quinic acid is also present in a green tea extract, a black tea extract, and a coffee extract, but is highest in a roasted coffee bean powder.

Since a coffee bean powder including a quinic acid through roasting is not a synthetic material, the coffee bean powder may have high safety, may not deteriorate an original flavor of food, and may sufficiently enhance a spicy taste even when being added in a small amount.

In this case, when the roasted coffee bean powder is included in the kimchi seasoning in an amount less than 5 parts by weight, an increase in spicy taste is insufficient. Thus, a more kimchi powder should be added to the kimchi seasoning, or a more kimchi seasoning should be added to the chinese cabbage leaves, and when the kimchi is stored for a long time, a spicy taste may be reduced. When the roasted coffee bean powder is included in the kimchi seasoning in an amount exceeding 10 parts by weight, a unique flavor of the kimchi may be greatly changed.

In the present invention, since the fruit extract of the pepper is added to the kimchi seasoning, a fermentation odor may be prevented in the kimchi, and thus, the kimchi may express a refreshing flavor such as a hot and spicy taste for a long time.

In general, a fermentation odor is an odor component such as acetaldehyde, crotonaldehyde, an acetic acid, ethyl acetate, dimethyl sulfide, 4-methylmercapto-3-butenyl cyanide, 4-methylmercapto-3-butenyl isothiocyanate, methyl methane thiosulfinate (methylallicin), or furfural.

In order to suppress such a fermentation odor, an enzyme (oxidase, peroxidase, or the like) involved in an odor of chinese cabbage may be inactivated, or a spice such as red pepper or garlic may be mixed, but an effect of reducing the fermentation odor may not be sufficient over time.

In the present invention, in order to suppress the fermentation odor, it is possible to use the fruit extract of the pepper which reduces activity of myrosinase capable of generating a fermentation odor.

That is, the fruit extract of the pepper may function as an activity reducing agent of myrosinase in order to reduce activity of the myrosinase which is an enzyme that hydrolyzes a bond of thioglucoside.

As pepper, an immature fruit (having green or yellowish green) is black pepper, and a dried substance of a mature fruit (having yellow or red) is white pepper.

A fruit extract of pepper or a powder obtained by drying and pulverizing a fruit itself of pepper may be used.

In extracting a fruit of pepper, alcohol, distilled liquor such as soju or cheongju, or water may be used as an extraction solvent. Generally used methods may be used for the extracting without limitation and may include a method of dipping a fruit as it is of pepper, a finely sliced material, or a pulverized material in a low temperature condition or a heating condition.

In the present invention, it is more preferable to use white pepper which functions as an activity reducing agent of myrosinase better.

When the fruit extract of the pepper is included in the kimchi seasoning in an amount less than 5 parts by weight, when the kimchi is stored for a long time, a fermentation odor is strong, and a color of the kimchi is changed by activity of myrosinase. When the fruit extract of the pepper is included in the kimchi seasoning in an amount exceeding 10 parts by weight, a unique flavor of the kimchi may be greatly changed.

The fruit extract of the pepper may be used in an amount of 0.1 to 0.15 parts by weight with respect to 100 parts by weight of the chinese cabbage.

In the present invention, a fermented red pepper paste may be further added to the kimchi seasoning, thereby improving a flavor of the kimchi.

The fermented red pepper paste obtained by fermenting red pepper with a yeast may enhance an appetite and a flavor by supplementing a strong and pungent taste of a kimchi caused by a spicy red pepper powder. In particular, the fermented red pepper paste may express a deep taste from a moment when the kimchi is made. Even when the kimchi is stored for a long time, the fermented red pepper paste may maintain such a flavor similar to an initial flavor and may suppress generation of a gas.

In this case, the fermentation may be performed at a temperature ranging from 20° C. to 40° C. for 2 months to 3 months to allow the fermented red pepper paste to include water at a content ranging from 70 wt % to 75 wt %.

Since the fermented red pepper paste has a water content, the fermented red pepper paste and a dried red pepper powder are easily and uniformly mixed. As a result, the red pepper powder may absorb water and taste components of the fermented red pepper paste and express a uniform flavor without disharmony.

When red pepper is fermented, a spicy taste and a brewing aroma may be generated to increase an appetite and a flavor.

In this case, ethyl alcohol may be further added in an amount of 0 to 6 parts by weight with respect to 100 parts by weight of the fermented red pepper paste.

The ethyl alcohol may preserve a flavor of the fermented red pepper paste for a long time. However, the ethyl alcohol is added in an amount exceeding 6 parts by weight, an odor of the ethyl alcohol may be generated to change the flavor of the fermented red pepper paste.

In the present invention, the fermented red pepper paste may be added in an amount of 0 to 30 parts by weight with respect to 100 parts by weight of the red pepper powder. However, when the fermented red pepper paste is added in an amount exceeding 30 parts by weight, a flavor may be improved to arouse an appetite, but a red color of the kimchi seasoning may become thin and a spicy taste thereof may be reduced.

Meanwhile, after the pickling, an operation of treating the sheets of the chinese cabbage leaves with the ethyl alcohol in the presence of a strong electrolyte, performing heating to inactivate an enzyme, and storing the sheets of the chinese cabbage leaves at a low temperature to maintain tissues of the chinese cabbage leaves may be further performed.

The operation is for suppressing destruction of original tissue of chinese cabbage to allow a kimchi to continuously express an original texture and a crispy chewing feeling even when the kimchi is made of chinese cabbage and stored for a long time.

As a method of suppressing the destruction of the tissue of the chinese cabbage, there is a method of treating the kimchi with superheated steam and cooling the kimchi to inactivate activity of peroxidase.

However, in the method, even when an enzyme is inactivated, the tissue is easily destroyed by high temperature treatment, and thus, a texture at the time of eating chinese cabbage is reduced.

In the present invention, an enzyme is inactivated at a low temperature for a short time through heating by allowing a strong electrolyte and ethyl alcohol to permeate into tissue of chinese cabbage.

Ethyl alcohol is a main ingredient of alcoholic drink, and an ethyl alcohol aqueous solution has a disinfecting action. In the present invention, ethyl alcohol having a concentration of 30 wt % to 70 wt % may be used.

An electrolyte is a material which is dissolved in water and divided into cations and anions. In the present invention, a strong electrolyte such as sodium chloride, magnesium chloride, potassium chloride, or calcium chloride may be used.

The heating may be performed for 20 seconds to 60 seconds in hot water at a temperature ranging from 70° C. to 90° C. Next, water may be removed from the chinese cabbage, and the chinese cabbage may be left at a temperature ranging from 0° C. to 10° C. for 24 hours to 72 hours.

In order to inactivate the enzyme, in the heating, microwave heating may be performed in addition to using the hot water.

The microwave heating may be a dielectric heating method of performing heating using frictional heat between molecules by irradiating a microwave to vibrate molecules of water and may use a microwave oven.

A microwave with a frequency of 1,450 MHz is generally used. In the present invention, the microwave may be irradiated in a certain amount such that the temperature of material rises up to 70° C. to 80° C.

As described above, in the present invention, even when a kimchi is made of chinese cabbage and stored for a long time, degradation of an exterior of the kimchi may be small, and a chewing feeling at the time of eating the kimchi may be maintained crisp without falling off.

Hereinafter, the present invention will be described in more detail with reference to Examples and Comparative Examples.

It is understood by those skilled in the art that the Examples and Comparative Examples are only for describing the present invention in more detail and that the scope of the present invention is not limited by the Examples in accordance with the point of the present invention.

### EXAMPLE 1

Sheets of chinese cabbage leaves were prepared by cutting off a root of chinese cabbage, spreading and separating chinese cabbage leaves into sheets, washing the chinese cabbage leaves.

The sheets of the chinese cabbage leaves were pickled with a brine pickling solution including a 20wt % salt aqueous solution for 6 hours.

A kimchi seasoning was prepared by ripening a mixture at a temperature of 5° C. for 24 hours, wherein the mixture was obtained by mixing 20 parts by weight of an anchovy sauce, 20 parts by weight of a sauced shrimp, 30 parts by weight of minced garlic, 50 parts by weight of ginger, 30 parts by weight of starch syrup, 10 parts by weight of L-monosodium glutamate, 10 parts by weight of a roasted coffee bean powder, and 10 parts by weight of a fruit extract of pepper with respect to 100 parts by weight of a red pepper powder.

In this case, the fruit extract of the pepper used a supernatant obtained by dipping 50 g of pepper, in which white pepper particles having an average diameter of 3 mm are each divided into eight pieces, into 500 g of a 60 wt % ethanol aqueous solution at room temperature for 2 days, and then, removing solid residues.

The kimchi seasoning was uniformly applied on the sheets of the chinese cabbage leaves, and then, the sheets of the chinese cabbage leaves were sequentially stacked and packaged, thereby manufacturing a sheet kimchi.

### EXAMPLE 2

A sheet kimchi was manufactured in the same manner as in Example 1, except that a fermented red pepper paste was added to the kimchi seasoning of Example 1 in an amount of 20 parts by weight.

In this case, the fermented red pepper paste was a fermented red pepper paste in which red pepper was washed with water, pulverized, and powdered, and a yeast was added to the powdered red pepper and fermented at a temperature of 35° C. for 2 months and then heated to inactivate the yeast.

### EXAMPLE 3

A sheet kimchi was manufactured in the same manner as in Example 1, except that, before the kimchi seasoning was applied after the pickling in Example 1 as described above, a treatment was further performed in which soju was added such that a content of alcohol in the pickling solution was 40 wt %, the sheets of the chinese cabbage leaves were further dipped for 20 minutes, taken out of the picking solution, and treated in hot water at a temperature of 80° C. for 20 seconds, water was removed by blowing air, and then the sheets of the chinese cabbage leaves were left at a temperature of 5° C. for 48 hours.

### EXAMPLE 4

A sheet kimchi was manufactured in the same manner as in Example 1, except that the treatments of Example 2 and Example 3 were further performed in Example 1.

### Control Group

A sheet kimchi was manufactured in the same manner as in Example 1, except that a roasted coffee bean powder and a fruit extract of pepper were excluded form the kimchi seasoning of Example 1.

### Comparative Example 1

A sheet kimchi was manufactured in the same manner as in Example 1, except that a roasted coffee bean powder was excluded form the kimchi seasoning of Example 1.

### Comparative Example 2

A sheet kimchi was manufactured in the same manner as in Example 1, except that an unroasted coffee bean powder was used in the kimchi seasoning of Example 1 instead of the roasted coffee bean powder.

### Comparative Example 3

A sheet kimchi was manufactured in the same manner as in Example 1, except that a fruit extract of white pepper was excluded form the kimchi seasoning of Example 1.

### Comparative Example 4

A sheet kimchi was manufactured in the same manner as in Example 1, except that a fruit extract of black pepper was used in the kimchi seasoning of Example 1.

After the sheet kimchis of Examples and Comparative Examples were stored at a temperature of 10° C. for 3 months, a sensory test was performed thereon, and results of the sensory test were shown in Table 1 below.

In the sensory test, ten trained assessors performed sensory evaluation on generation of an increase in spicy taste, generation of a fermentation odor, overall palatability (flavor), crisp chewiness, and a degree of change in color (yellow, blue, or red). Three points were given to Control Group. As a result of sensory evaluation was improved as compared with Control Group, the result was evaluated as four points and five points, and as a result of sensory evaluation was deteriorated Control Group, the result was evaluated as two points and one point.

TABLE 1

| | Increase | Generation of | Overall | Crisp | Degree of |
|---|---|---|---|---|---|
| | in spicy | fermentation | palat- | chewi- | change in |
| | taste | odor | ability | ness | color |
| Example 1 | 4.2 | 4.1 | 4.1 | 3.1 | 3.8 |
| Example 2 | 4.1 | 4.4 | 4.3 | 3.2 | 4.1 |
| Example 3 | 4.6 | 4.2 | 4.3 | 4.7 | 3.9 |
| Example 4 | 4.3 | 4.6 | 4.5 | 4.5 | 4.3 |
| Comparative | 3.2 | 3.9 | 3.3 | 3.1 | 3.5 |
| Example 1 | | | | | |
| Comparative | 3.5 | 3.8 | 3.6 | 3.2 | 3.6 |
| Example 2 | | | | | |
| Comparative | 3.1 | 2.1 | 2.6 | 3.1 | 2.6 |
| Example 3 | | | | | |
| Comparative | 3.2 | 3.3 | 3.2 | 2.9 | 3.3 |
| Example 4 | | | | | |
| Control Group | 3.0 | 3.0 | 3.0 | 3.0 | 3.0 |

From results of Example 1 in Table 1, it is confirmed that, even after the sheet kimchi according to the present invention is stored for 3 months, a spicy taste is increased, and a flavor is excellent, and a change in color is small as compared with Control Group. It is conformed that the sheet kimchi according to the present invention expresses a flavor similar to an initial flavor in which the kimchi is made.

According to the present invention, since a roasted coffee bean powder and a fruit extract of pepper are included in a kimchi seasoning, a spicy taste of a kimchi is increased, and a decrease in spicy taste is suppressed even when the kimchi is stored for a long time.

In addition, even when the kimchi is stored for a long time, a strong smell (fermentation odor) peculiar to the kimchi is purified to maintain a refreshing taste right after the kimchi is made.

What is claimed is:

1. A method of manufacturing a sheet kimchi having a spicy taste, the method comprising:
separating chinese cabbage into sheets to prepare sheets of chinese cabbage leaves;
pickling the sheets of the chinese cabbage leaves with a brine pickling solution;
preparing a kimchi seasoning by mixing 20 to 30 parts by weight of an anchovy sauce, 20 to 30 parts by weight of a sauced shrimp, 40 to 60 parts by weight of minced garlic, 40 to 60 parts by weight of ginger, 20 to 30 parts by weight of starch syrup, 5 to 10 parts by weight of L-monosodium glutamate, 5 to 10 parts by weight of a roasted coffee bean powder, and 5 to 10 parts by weight of a fruit extract of pepper with respect to 100 parts by weight of a red pepper powder; and
applying the kimchi seasoning on the sheets of the chinese cabbage leaves and sequentially stacking and packing the sheets of the chinese cabbage leaves.

2. The method of claim 1, wherein the fruit extract of the pepper is a supernatant obtained by dipping a fruit of pepper into an ethanol aqueous solution at room temperature and separating solid residues.

3. The method of claim 1, wherein the fruit of the pepper is a fruit of white pepper.

4. The method of claim 1, wherein a fermented red pepper paste is further included to the kimchi seasoning in an amount of 0 to 30 parts by weight.

5. The method of claim 4, wherein the fermented red pepper paste includes water at a content ranging from 70 wt % to 75 wt % by fermenting red pepper with an enzyme at a temperature ranging from 20° C. to 40° C. for 2 months to 3 months.

6. The method of claim 1, wherein, after the pickling, the sheets of the chinese cabbage leaves are treated with ethyl alcohol in an electrolyte, are heated to inactivate an enzyme, and are stored at a low temperature to maintain tissue of the chinese cabbage.

7. The method of claim 6, wherein the electrolyte is one strong electrolyte selected from among sodium chloride, magnesium chloride, potassium chloride, and calcium chloride, and
a concentration of the ethyl alcohol ranges from 30 wt % to 70 wt %.
